(19) United States
(12) Patent Application Publication
(10) Pub. No.: US 2026/0291329 A1
(43) Pub. Date: Sep. 24, 2026

(54) Crankshaft-based dual-axis scanning drive mechanism

(71) Applicant: VIETTEL GROUP, Ha Noi City (VN)

(72) Inventors: XUAN BACH LUU, Hung Yen Province (VN); THI HANG LE, Ha Noi City (VN); HOAI SON NGUYEN, Ha Noi City (VN)

(73) Assignee: VIETTEL GROUP, Ha Noi City (VN)

(21) Appl. No.: 19/455,798

(22) Filed: Jan. 21, 2026

(30) Foreign Application Priority Data
Mar. 18, 2025 (VN) 1-2025-01843

(51) Int. Cl. H02K 7/118; H02K 7/08

(52) U.S. Cl. CPC H02K 7/118; H02K 7/08

(57) ABSTRACT

A crankshaft-based dual-axis scanning drive mechanism is disclosed. The mechanism is configured to generate controlled scanning rotational motion about two substantially perpendicular axes, including a horizontal axis and a vertical axis. Rotational motion is transmitted through a crankshaft-connecting rod linkage system, wherein the horizontal and vertical rotation shafts intersect to define a common rotational center, and the driving motors are positioned away from the rotational center. The drive mechanism comprises a base assembly, a rotating assembly, and a device assembly, with motors arranged away from the rotational center to reduce structural mass and improve spatial efficiency. Position sensors and angular velocity sensors are arranged concentrically with the rotation shafts to provide accurate motion feedback. The disclosed mechanism is suitable for use in scanning, tracking, communication, radar, and meteorological devices requiring compact size, smooth motion, and high positional accuracy.

### TECHNICAL FIELD

The invention relates to a crankshaft-type driving mechanism configured to generate scanning rotational motion along two perpendicular axes (horizontal axis-vertical axis), suitable for use in target detection and weather forecasting devices. Specifically, the invention describes the design of a product belonging to the class of dual-axis driving devices, comprising a horizontal-axis mechanical motion mechanism, a vertical-axis mechanical motion mechanism, a motor, and sensors for measuring position and angular velocity.

### BACKGROUND OF THE INVENTION

Solutions are known from previously published patents and articles related to dual-axis driving mechanisms for rotating devices, specifically for horizontal-vertical scanning. However, these solutions have the following drawbacks:

U.S. Patent Application No. US2024360891 discloses a gear-driven mechanism generating scanning rotational motion along two perpendicular axes. In the horizontal direction, the system employs a double-helix semicircular spring gear to transmit motion and guide it via ball bearings. In the vertical direction, the system uses a double-helix spring gear reduction box to transmit motion. Other known solutions also typically employ gear-based drive structures. Although this type of configuration provides high torque, it is complex, has a fixed transmission ratio, and produces noise and vibration, thereby limiting its suitability for applications requiring high precision.

Crankshaft-based configurations are also known; however, the drive mechanisms in these solutions do not provide an accurate coordination between horizontal and vertical motions to achieve precise scanning rotation.

To overcome the aforementioned limitations, the invention proposes a crankshaft-type driving mechanism configured to generate scanning rotational motion along two perpendicular axes, which is distinct from any previously disclosed inventions.

### BRIEF SUMMARY OF THE INVENTION

The objective of the invention is to enhance the scanning capability of the driving mechanism, particularly for large devices, to provide smoother motion and minimize transmission errors along the horizontal and vertical axes. In addition, the mechanism optimizes the spatial arrangement of position sensors and angular velocity sensors and reduces the overall mass of the drive assembly.

To achieve the above objectives, the inventors propose a dual-axis driving mechanism comprising components arranged in assemblies, specifically:

The base module (1) comprises: a main base (4), a horizontal-axis motor (5), a hollow frame (6), a main support pedestal (7), first bearing stoppers (8), first ball bearings (9), a horizontal rotation shaft (10), a rotation support shaft (11), damping mounts (12) and damping spring balls (13),

The rotation module (2) comprises: a vertical-axis motor (14), second ball bearings (15), second bearing stoppers (16), a horizontal angle scanning pin (17), a vertical motor shaft bushing (18), couplings (19), third ball bearings (20), third bearing stoppers (21), a first crankshaft (22), a connecting rod (23), a second crankshaft (24), a vertical damping mount (25), a vertical-axis bracket (26), a sensor shaft stopper (27), a vertical-axis position sensor mount (28), a vertical-axis position sensor (29), a vertical rotation shaft (30), a horizontal-axis position sensor (31), fourth ball bearings (32) and a horizontal-axis position sensor mount (33),

Device assembly (3) comprises: fourth bearing stoppers (34), a device mount (35), mounting posts (36), an angular velocity sensor housing (37), an angular velocity sensor (38), an angular velocity sensor housing cover (39), and a dowel pin (40).

The invention is applicable to target-tracking scanning devices, communication equipment, and radar systems.

### BRIEF DESCRIPTION OF THE DRAWING

FIG. 1 is a schematic illustration of the crankshaft drive mechanism according to the present invention.

FIG. 2 is an exploded view of the components of the crankshaft drive mechanism according to the present invention.

FIG. 3(a)-(d) are various views and cross-sectional illustrations of the crankshaft drive mechanism according to the present invention.

FIG. 4(a)-(b) are schematic illustrations of the crankshaft drive mechanism according to the present invention in states corresponding to rotation of the vertical-axis motor.

FIG. 5(a)-(b) are schematic illustrations of the crankshaft drive mechanism according to the present invention in states corresponding to rotation of the horizontal-axis motor.

### DETAILED DESCRIPTION OF THE INVENTION

The invention will now be described with reference to preferred embodiments. Identical reference numerals in the drawings denote the same or similar components or parts.

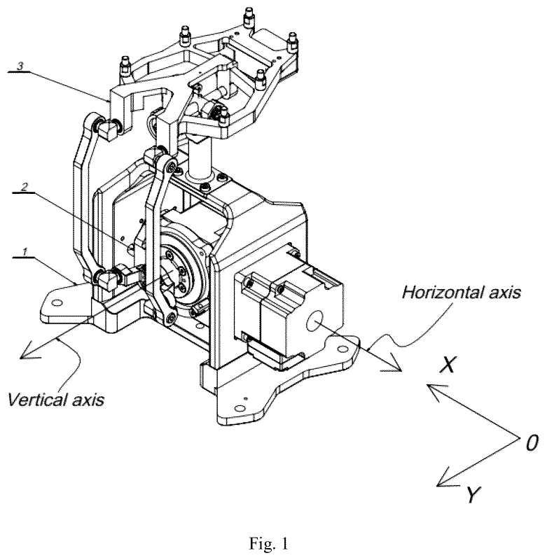

As illustrated in FIG. 1, the crankshaft-type driving mechanism generating scanning rotational motion along two perpendicular axes according to the invention comprises a base assembly (1), a rotating assembly (2), and a device assembly (3).

In this description, as illustrated in FIG. 1, the horizontal direction corresponds to the X-axis, and the vertical direction corresponds to the Y-axis. The use of the terms “horizontal” and “vertical” is not intended to limit the invention but solely to clearly illustrate the rotational motion generated by the mechanism according to the invention.

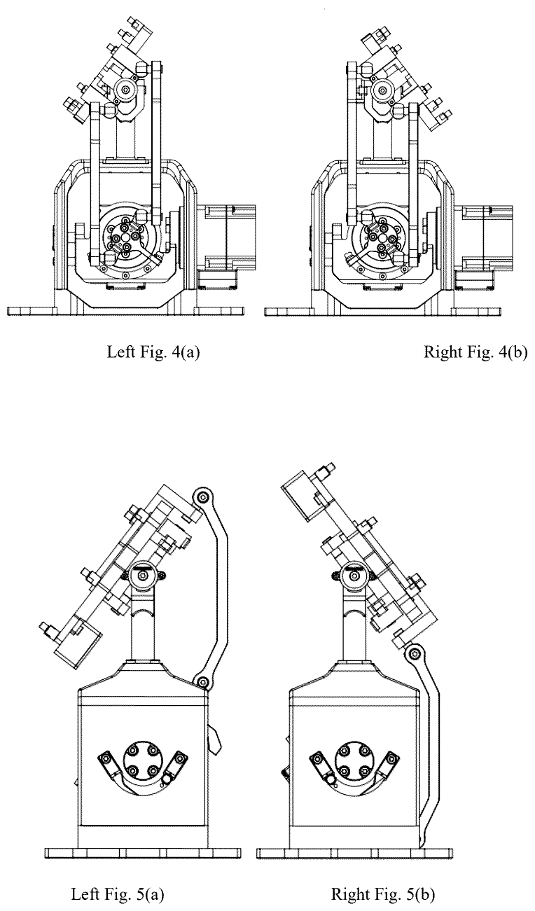

As illustrated in FIGS. 1, 4, and 5, the mechanism according to the invention generates rotational motion of the device assembly (3) for scanning along the horizontal and vertical directions through the rotation of the rotating assembly.

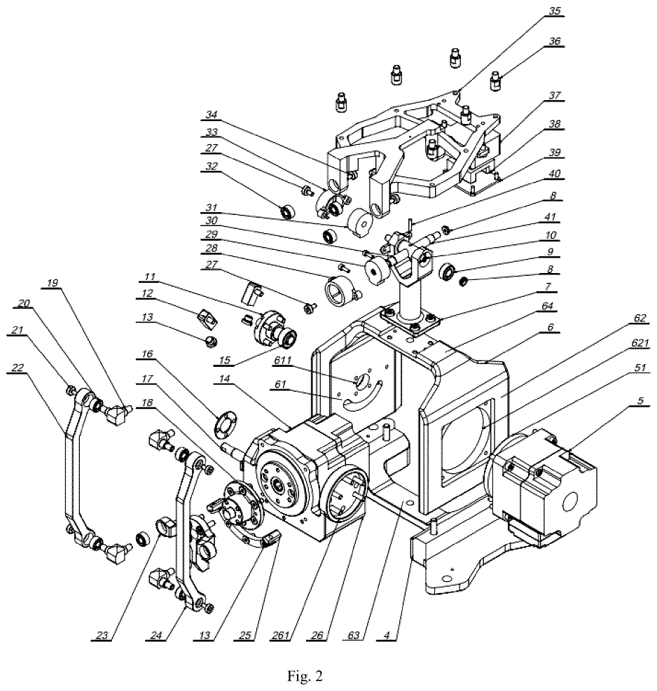

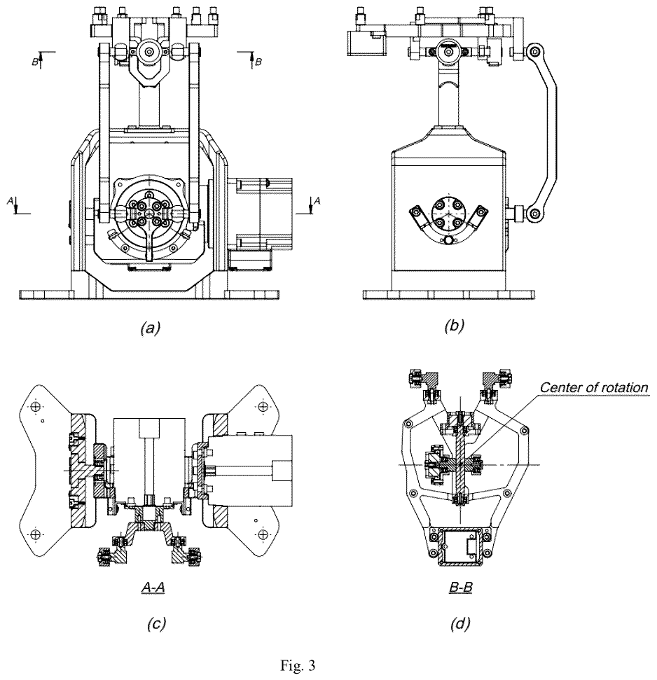

FIG. 1 illustrates a general design of the driving mechanism according to the invention. FIG. 2 depicts and lists the detailed components of the mechanism. FIG. 3 shows the front, side, and sectional views at the active positions of the mechanism operating along both axes.

The base assembly (1): the main support of the driving mechanism. The base assembly (1) comprises:

The main base (4): is a mechanical component made of an aluminum alloy, serving as the general mounting base for the entire mechanism, and having four pre-formed smooth bore holes for connection with external mounting bases during use.

The horizontal-axis motor (5): is an electronic component with an integrated reduction gearbox, configured to generate rotational motion along the horizontal direction. The horizontal motor (5) includes a flange (51). The motor (5) is mounted on the main base (4), and its front end extends through the second through-hole (612) of the hollow frame (6), substantially perpendicular to the side walls (61, 62) of the hollow frame (6).

The hollow frame (6): is a mechanical component having a specially shaped arcuate structure with a hollow central portion, providing space for the horizontal rotating assembly to move. In addition, the hollow frame (6) has rounded edges to minimize friction of electrical cables transmitting signals from the position sensors (29, 31) and the angular velocity sensor (38) to the main base (4) during scanning rotation. The hollow frame (6) is bounded by a left side wall (61), a right side wall (62), a bottom wall (63), and a top wall (64). The left side wall (61) includes a first through-hole (611) and an arcuate groove (612), with the first through-hole (611) serving as the center of the arc, while the right side wall (62) includes a through-hole (621).

The main support pedestal (7) is a mechanical component made of stainless steel, serving as a support for the entire device assembly (3). The main support pedestal (7) is mounted on the upper surface of the top wall (64) of the base assembly.

The first bearing stoppers (8): is a mechanical component made of stainless steel, mounted to retain the inner rings of the first ball bearing (9) and the fourth ball bearing (32), preventing these ball bearings from slipping out of their bearing seats.

The first ball bearing (9): is a standard mechanical component, configured to reduce friction between the horizontal rotation shaft (10) and the main support pedestal (7).

The horizontal rotation shaft (10): is a precision mechanical component made of stainless steel, designed with multiple stepped diameters, configured to rotate when the horizontal motor (5) operates. The front end of the horizontal rotation shaft (10) has a nominal dimension matching the nominal diameter of the bore in the horizontal position sensor (31). The front end of the shaft is pre-threaded with an M2 screw thread to mate with the sensor using an M2 bolt, ensuring transmission of horizontal rotational motion from the horizontal-axis motor (5) to the horizontal-axis position sensor (31).

The rotation support shaft (11): is a precision circular mechanical component made of stainless steel, serving as a support for the horizontal rotating assembly (2). Specifically, the rotation support shaft (11) extends through the first through-hole of the base assembly to mount with the vertical bracket (26), which will be described later.

The two damping mounts (12): components made of stainless steel, configured to receive the damping ball elements (13). The assembly consisting of the damping mounts and the damping ball elements is installed at the two ends of the arcuate slot (612).

The damping spring balls (13): an elastic component configured to provide shock absorption and to limit travel when the mechanism performs its scanning rotation, thereby reducing impact and vibration when the mechanism reaches its end positions.

According to the embodiment of the invention, the base frame (6) is configured so as to avoid interference when the first crank shaft (22) and the second crank shaft (24) move and sweep rotationally along two axes over a wide angular range.

The rotating assembly (2) is configured as follows:

The vertical-axis motor (14): is an electronic component that may have dimensions and specifications similar to those of the horizontal-axis motor. The motor incorporates an internal reduction gearbox and generates rotational motion about a vertical axis perpendicular to the horizontal axis. The vertical-axis motor (14) is mounted to the vertical bracket (26), and the vertical bracket is mounted to the base assembly, specifically within the hollow frame. The rotation support shaft (11) passes through the first through-hole to support the vertical-axis motor (14).

The second ball bearings (15): is a standard mechanical component and is configured to reduce friction between the rotation support shaft (11) and the vertical bracket (26).

The second bearing stopper (16): is a mechanical component made of an aluminum alloy and is configured to retain the outer ring of the second ball bearing (15).

The horizontal angle scanning pin (17) is a mechanical component made of stainless alloy steel, fixedly mounted on the vertical bracket (26). Rotation of the horizontal-axis motor causes the horizontal angle scanning pin (17) to move along a defined angular range within the arcuate groove (612), with its travel limited by the damping ball element (13).

The vertical motor shaft bushing (18): is a circular mechanical component made of aluminum alloy, precisely mounted with the vertical-axis motor (14) using two standard cylindrical pins.

The coupling (19) is a precision mechanical component made of aluminum alloy, accurately machined at both shaft ends to mount the third ball bearings (20). The coupling has two shaft ends oriented perpendicularly to each other, each end pre-threaded with an M2 screw to mate with shaft retainers, preventing the coupling from slipping along the two axes (vertical and horizontal) during motion. The coupling transmits motion from the first crankshaft (22) and the second crankshaft (24) to the device assembly (3).

The third ball bearings (20) are standard mechanical component, configured to connect the coupling (19) with the first and second crankshafts (22, 24).

The third bearing stopper (21) is a mechanical component made of stainless steel, configured to secure the coupling (19) from moving along its longitudinal axis after being mounted onto the third ball bearings (20).

The first crankshaft (22) is a mechanical component made of stainless steel alloy, providing rigidity and resistance to bending and torsional moments, driven by the rotational motion of the connecting rod (23).

The connecting rod (23) is a mechanical component made of stainless alloy steel, designed with two ends mounted with third ball bearings (20). The connecting rod has a recess for precise mounting with the vertical-axis motor (14). The connecting rod (23) functions both to perform scanning rotation and to provide travel limitation, restricting the angular motion of the vertical axis. When the connecting rod (23) contacts the damping ball element (13), the vertical motion is stopped.

The second crankshaft (24) is a mechanical component made of stainless steel alloy, having a structure symmetrical to the first crankshaft (22), providing rigidity and resistance to bending and torsional moments, driven by the rotational motion of the connecting rod (23). Both crankshafts (22 and 24) are designed as C-shaped bars, with bearings mounted at both ends to connect the coupling (19) with the crankshafts (22, 24) during motion, ensuring smooth movement between the coupling and the crankshafts while reducing friction.

Each lower end is connected to a corresponding end of the connecting rod via the coupling (19) to be driven by the connecting rod, and each upper end is connected to the device assembly through the coupling (19) to drive the device assembly to rotate along the vertical axis.

The vertical damping mount (25) is a mechanical component made of stainless steel, designed in a semicircular shape with two protrusions to mount two damping ball elements (13). The vertical damping mount (25) is attached to the vertical bracket (26) via M2 bolt fasteners.

The vertical-axis bracket (26) is a precision mechanical component made of aluminum alloy, configured to mount the vertical-axis motor (14). The vertical-axis bracket (26) is designed with two positioning recesses to simultaneously accommodate both the horizontal-axis motor (5) and the vertical-axis motor (14). A key feature is that the axes passing through the centers of these two recesses intersect at a single point; in other words, the axis of the horizontal-axis motor (5) and the axis of the vertical-axis motor (14) lie in the same plane and intersect, being essentially perpendicular to each other.

The sensor shaft stopper (27) is a mechanical component made of aluminum alloy, configured to secure the horizontal rotation shaft (10) and the vertical rotation shaft (30) to the two-axis position sensors, namely the vertical position sensor (28) and the horizontal position sensor (31).

The vertical-axis position sensor mount (28) is a mechanical component made of aluminum alloy, configured to secure the vertical position sensor (29).

The vertical-axis position sensor (29) is an electronic device mounted concentrically with the vertical rotation shaft (30), configured to measure the vertical angular position of the device assembly (3) when the vertical-axis motor (14) rotates.

The vertical rotation shaft (30) is a mechanical component made of stainless steel, firmly mounted with the fourth ball bearing (32). The front end of the vertical rotation shaft (30) has a nominal dimension matching the bore of the vertical position sensor (29), ensuring transmission of vertical rotational motion from the vertical-axis motor (14) to the vertical position sensor (29). The vertical rotation shaft is perpendicular to the horizontal rotation shaft (10).

As illustrated in FIG. 2, the vertical rotation shaft (30) is inserted through a hole formed in the center of the horizontal rotation shaft (10). The dowel pin (40): a mechanical component made of stainless steel, having a conical cylindrical shape, configured to connect the vertical rotation shaft (30) and the horizontal rotation shaft (10).

The horizontal-axis position sensor (31) is an electronic device mounted concentrically with the horizontal rotation shaft (10), configured to measure the horizontal angular position of the device assembly (3) when the horizontal-axis motor (5) rotates.

The fourth ball bearing (32) is a mechanical component, having the same dimensions as the third ball bearings (20), i.e., 4×9×4 mm, configured to connect the coupling (19) with the device mount (35). The fourth ball bearing (32) is installed in the bearing seat of the device mount (35).

The horizontal-axis position sensor mount (33) is a circular mechanical component made of aluminum alloy, configured to mount and secure the horizontal position sensor (31). The mount (33) has the same dimensions and shape as the vertical position sensor mount (28).

The device assembly (3) comprises:

The fourth bearing stopper (34) is a mechanical component made of stainless steel, configured to secure the coupling (19) from moving along its longitudinal axis after being mounted onto the third ball bearings (20).

The device mount (35) is a mechanical component made of aluminum alloy, configured to mount an angular velocity measurement unit and mounting posts (36) for connection with external devices as required. The device mount (35) is specially designed with four bearing mounting positions: two ball bearings (20) are mounted with two couplings (19), and the remaining two ball bearings (32) are mounted with the vertical rotation shaft (30). The four bearings provide a connection between the device mount, the couplings, and the vertical rotation shaft, ensuring smooth movement of the device mount along both axes during operation.

The mounting post (36) is a mechanical component made of stainless steel, with an external M2 thread machined at the shaft end for attachment to external devices.

The angular velocity sensor housing (37) is a mechanical component made of aluminum alloy, configured to mount the angular velocity sensor (38) and to protect the electronic device from external interference.

The angular velocity sensor (38) is an electronic device configured to measure angular velocity.

The angular velocity sensor housing cover (39) is a mechanical component made of aluminum alloy, configured as a cover for the angular velocity measurement unit housing, protecting the electronic device from external interference.

The rotating assembly (2) and the device assembly (3) are connected via two couplings (19).

According to the design of the invention, the horizontal-axis motor (5) is controlled to generate rotational motion along the horizontal direction, and the vertical-axis motor (14) is controlled to generate rotational motion along the vertical direction. The rotational motion of the device is transmitted from the horizontal and vertical motors through the first and second crankshafts (22, 24) and the connecting rod (23). Information regarding angular position and angular velocity is sent to the vertical position sensor (29), the horizontal position sensor (31), and the angular velocity sensor (38). Based on feedback of angular position and angular velocity from these sensors, appropriate control parameters are calculated and applied to meet the requirements of the drive mechanism. During rotation of the device assembly, the horizontal-axis motor (5) and the vertical-axis motor (14) drive the device assembly to rotate along two axes and move about a rotational center. This rotational center is the intersection point of the vertical rotation shaft (30) and the horizontal rotation shaft (10), as illustrated in FIGS. 2 and 3(d).

The use of crankshafts represents a distinguishing feature of the mechanism. The horizontal and vertical motors are positioned away from the rotational center of the device assembly, which is the intersection point of the vertical rotation shaft (30) and the horizontal rotation shaft (10). The installation area for the vertical and horizontal rotation shafts accommodates only the position sensors and the angular velocity sensor, thereby increasing space for mounting other components on the device assembly. As a result, the scanning radius of the mechanism is optimized and minimized. The mechanism is suitable for applications requiring compact dimensions. It is constructed from mechanical components made of aluminum alloy and stainless steel, which helps optimize the overall weight of the mechanism.

1. A crankshaft-based dual-axis scanning drive mechanism, comprising:
a base assembly including a main base and a hollow frame;
a horizontal-axis motor mounted to the base assembly and configured to generate rotational motion about a horizontal axis;
a vertical-axis motor configured to generate rotational motion about a vertical axis;
a main support pedestal mounted on the hollow frame;
a horizontal rotation shaft supported at opposite ends by the main support pedestal;
a vertical rotation shaft arranged perpendicular to and intersecting the horizontal rotation shaft;
a device assembly;
a coupling having two cylindrical shaft ends arranged perpendicular to each other;
a connecting rod driven by the vertical-axis motor and configured to oscillate through a predetermined angular range;
a first crankshaft and a second crankshaft, each crankshaft comprising an upper end and a lower end,
wherein each lower end is coupled to a corresponding end of the connecting rod via the coupling so as to be driven by the connecting rod, and
wherein each upper end is coupled to the device assembly via the coupling so as to drive the device assembly to rotate about the vertical axis.

2. The drive mechanism according to claim 1, wherein the horizontal rotation shaft and the vertical rotation shaft intersect at a point defining a rotational center of the device assembly.

3. The drive mechanism according to claim 2, wherein the vertical rotation shaft extends through a hole formed in the horizontal rotation shaft and is fixed thereto by a dowel pin.

4. The drive mechanism according to claim 1, further comprising a vertical damping mount attached to a vertical-axis bracket, the vertical damping mount being configured to limit angular travel of the connecting rod during oscillation of the vertical-axis motor.

5. The drive mechanism according to claim 1, further comprising at least two damping mounts disposed at opposite ends of an arcuate groove formed in the base assembly, the damping mounts being configured to limit angular travel of the horizontal rotation shaft.

6. The drive mechanism according to claim 1, wherein the couplings are connected to the crankshafts and the device assembly through ball bearings.
